(19) United States
(12) Patent Application Publication
(10) Pub. No.: US 2016/0312823 A1
(43) Pub. Date: Oct. 27, 2016

(54) ROLLING-ELEMENT BEARING, HIGH SPEED BEARING AND COMPRESSOR

(71) Applicant: Aktiebolaget SKF, Goteborg (SE)

(72) Inventors: Tom De Rooster, Leest - Mechelen (BE); Rudolf Hauleitner, Steyr (AT)

(73) Assignee: Aktiebolaget SKF, Goteborg (SE)

(21) Appl. No.: 15/135,231

(22) Filed: Apr. 21, 2016

(30) Foreign Application Priority Data
Apr. 23, 2015 (DE) 102015207394.7

(51) Int. Cl. F16C 19/16; F16C 33/58

(52) U.S. Cl. CPC F16C 19/163; F16C 33/585; F16C 2360/00

(57) ABSTRACT

Embodiments relate to a rolling-element bearing comprising at least one outer ring (2) and at least one inner ring (3). Between the same a plurality of rolling elements (4) are arranged to support the inner ring (3) rotatably with respect to the outer ring (2). The outer ring (3) comprises at least one raceway (5, 7) more for the plurality of rolling elements (4) than the inner ring (3).

Embodiments relate to a rolling-element bearing, a high-speed support for rotatably supporting a first member with respect to a second member, and a compressor.

For rotatably supporting components, completely different rolling-element bearings or rolling-element bearing arrangements are used. In particular with high speed applications, here, for example, special requirements with respect to a support result due to occurring centrifugal forces. Based on the rigidity of the bearing arrangement, in a state in which load is applied—in contrast to a state without external load—a change of position of the rotor or the shaft results. The support is to prevent or at least limit a change or a shift of the axial position of the rotatably supported component, for example of a rotor or a shaft.

With conventional high-speed applications mainly ball bearings (angular contact ball bearings or four point contact ball bearings) in combination with cylindrical roller bearings are used. In such applications adequate lubrication is of particular importance. With other conventional high-speed applications frequently pre-loaded axial bearings, either four-point bearings (four-point contact ball bearing; abbreviation: FCBB) or angular contact ball bearings (ACBB) are used. By pre-loading and the use of several bearings, expenditure of material and workload may be clearly increased with such supporting means.

It is thus the object to provide an improved support. This object is solved by the rolling-element bearing, the high-speed support and the compressor according to any of the independent claims.

Embodiments relate to a rolling-element bearing comprising an outer ring and an inner ring. Between the inner ring and the outer ring a plurality of rolling elements are arranged in order to support the inner ring rotatably with respect to the outer ring. The outer ring comprises at least one raceway more than the inner ring.

Embodiments further relate to a high-speed support for rotatably supporting a first component with respect to a second component by means of at least rolling-element bearing according to one of the described embodiments. The rolling-element bearing may be operated or rotated with a speed factor of more than 750,000 mm/min which may also be referred to as the relative rotational speed. The speed factor here is the product of a pitch circle diameter of the bearing in mm and the speed in 1/min.

Embodiments further relate to a compressor comprising at least one rolling-element bearing according to the described embodiments, wherein the rolling-element bearing is arranged to rotatably support a rotor of the compressor. Additionally or alternatively, the compressor may also comprise the high-speed support, wherein the rotor is the first component.

In some embodiments, due to the fact that the outer ring comprises more raceways than the inner ring, it may be facilitated, for example, in particular with high-speed applications or compressors, but also in other applications, that centrifugal forces which occur and act upon the rolling elements may be absorbed better. In some embodiments, in this way an axial position may be maintained highly accurately and/or a change of an axial position of a rotatably supported component may be prevented or at least reduced.

For example, the outer ring may comprise two raceways and the inner ring may comprise one raceway. A difference of a contact angle of the rolling elements at the inner ring and the outer ring may thus be minimized in some embodiments. In some embodiments, the inner ring and the outer ring may for example be arranged as flush as possible with respect to each other at a standstill and/or also in operation. In other words, possibly a defined offset may exist in axial direction at least at one side between the inner ring and the outer ring and/or their side faces. The side faces may be front faces comprising at least one axial directional component. For example, the front faces may also be completely directed into one axial direction.

Additionally or alternatively, a face of the outer ring which is radially directed inwards may in its cross section comprise at least one section of a straight line. Possibly, the face of the outer ring directed radially inwards may in its cross section comprise a section of a circular arc. In embodiments in which the circular arc comprises greater radius of curvature than the rolling element, the rolling element may roll off in a punctiform way on the raceway. In some embodiments, the cross section has the form of a gothic arch.

Alternatively, the raceway of the outer ring may further comprise a protrusion comprising a larger extension radially inwards as compared to adjacent regions in axial direction. In some embodiments, this way a location of a contact point of the rolling element on the raceway may be determined very accurately. The at least one raceway of the inner ring or a section comprising the same may be implemented analog to what is described for the outer ring.

Alternatively or additionally, the rolling element may be in contact with at least one more raceway at the outer ring than at the inner ring during operation and/or when the bearing is not rotating. In some embodiments it may thus be facilitated that forces acting upon the bearing may be better absorbed and/or that more favorable bearing kinematics result. The rolling element may thus, when it is for example simultaneously in contact with one or several or even all raceways of the outer ring, simultaneously also be in contact with one or several or all raceways of the inner ring.

In embodiments in which the inner ring comprises exactly one raceway, the rolling element, when it is simultaneously in contact with the first and the second raceway of the outer ring, may further simultaneously be in contact with the exactly on raceway of the inner ring. In some embodiments, this way a more exact axial positioning may be facilitated.

The rolling element may be a ball, for example. In some embodiments, this way an at least theoretically punctiform contact between the raceway and the rolling element may result. In further embodiments, a barrel roller is utilized as a rolling element. Possibly, in some embodiments a theoretically linear contact may result between the rolling element and the raceway. Actual forms of contact may deviate from the theoretically desired ideal contact forms, for example due to a minimum deformation or wear and/or manufacturing tolerances.

Additionally or alternatively, the rolling element may comprise the same contact angle at least at two raceways of the outer ring. In some embodiments, thus a symmetrical outer ring may be utilized.

Possibly, the rolling element may comprise different contact angles at different raceways of the outer ring, for example at least at two raceways. In some embodiments, by using an asymmetrical outer ring applied forces may be taken into account.

Additionally or alternatively, the inner ring may be implemented asymmetrically at its face which is directed radially outwards. For example, at a side facing away from the raceway of the inner ring in axial direction, the inner ring may have a smaller dimension radially outwards than in an area or at a side at which the raceway is located. In some embodiments, due to an asymmetry of the inner ring, lubricant may be introduced better. Likewise, also a distribution of the lubricant, for example by a pump effect which may result at the asymmetrical form, may be improved. For example, the raceway or the area comprising a larger extension in axial direction may be arranged at the side in axial direction from which an axial force acts upon the bearing and/or the inner ring.

The embodiments disclosed in the above description, the subsequent claims and the attached drawings as well as their individual features may be of importance and implemented in their different implementations, individually and also in any combination for implementing an embodiment.

Thus, the FIGURE schematically illustrates the following view:

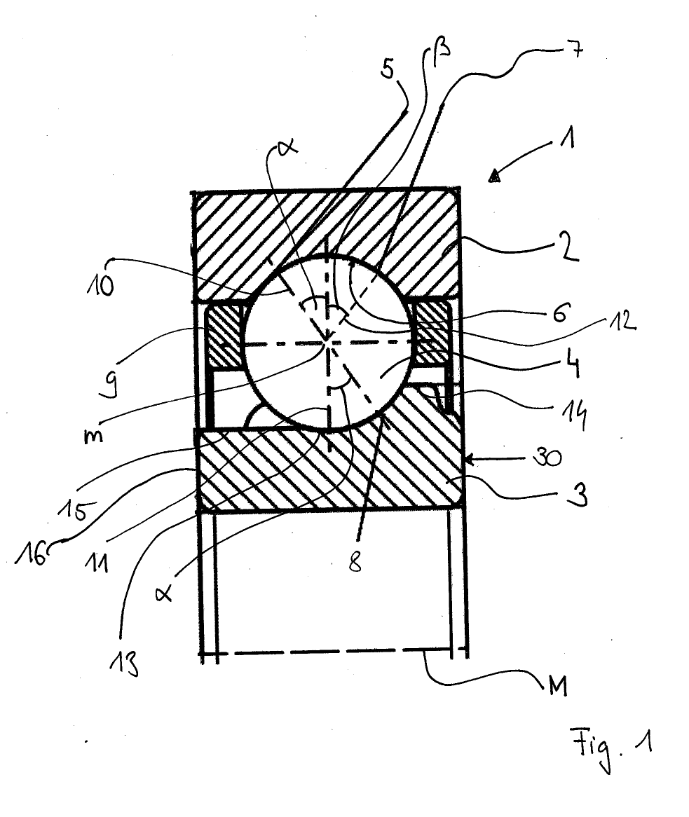

FIG. 1 shows a schematic cross-sectional illustration of a rolling-element bearing according to one embodiment.

In the following description of the attached drawings, like reference numerals relate to like or similar components. Further, summarizing reference numerals are used for components and objects which occur several times in one embodiment or in one illustration, but are described in common with reference to one or several features. Components or objects designated by like or summarizing reference numerals may be implemented alike, possibly, however also differently with respect to individual, several or all features, for example their dimensioning, as far as nothing else explicitly or implicitly results from the description.

FIG. 1 shows a schematic cross-sectional illustration of a rolling-element bearing 1 according to one embodiment. It is a section passing in parallel to a rotational axis and also through the same. The rolling-element bearing comprises an outer ring 2. and an inner ring 3. Between the inner ring 3 and the outer ring 2 a plurality of rolling elements are arranged, wherein one rolling element 4 is illustrated in FIG. 1. Above the rolling elements 4 the inner ring 3 is rotatably supported with respect to the outer ring 2. The outer ring 2 comprises at least one raceway more for the plurality of rolling elements 4 than the inner ring 3.

The rolling elements 4 are arranged in one row, implemented as balls and held in a cage 9. In some further embodiments which are not illustrated the cage may be omitted. Additionally or alternatively, the rolling elements may also be implemented as barrel rollers.

In the embodiment, the outer ring 2 comprises a further and/or second raceway 7 at its face 6 which is directed radially inwards at which also the raceway 5 is arranged which is the first raceway. The raceways 5 and 7 are arranged symmetrically with respect to each other. The outer ring 2 is an outer ring of conventional four-point bearing or an outer ring having a similar design. The inner ring 3 comprises exactly one raceway 8. The raceway 8 of the inner ring 3 is arranged diagonally opposite to the raceway 5. The inner ring 3 is a conventional inner ring of an angular contact ball bearing or an inner ring having a similar design.

The inner ring 3 is arranged radially within and concentrically with respect to the outer ring 2. In the axial direction M the two rings 3 and 2 are arranged completely or almost completely overlapping. In the axial direction, the two rings 3 and 2 have the same extension. In some further not illustrated embodiments the rings may also comprise a different axial extension in the axial direction. For example, the inner ring 3 may be arranged flush to the outer ring 2. The extension and/or the flush arrangement may possibly deviate in each direction by up to 0.005 mm for manufacturing reasons.

In some further non-illustrated embodiments, the inner ring and/or the outer ring may be divided.

In FIG. 1, the outer ring comprises two circular arc sections at its face 6 which is directed radially inwards, each of same including one of the raceways 5 and 7. A curvature radius of the circular arc section may here, for example, be greater by a factor of 1.01, 1.02, 1.03, 1.04, 1.05, 1.06, 1.07, 1.08, 1.09 or 1.20 than a radius of the rolling element 4. At one point, the face 6 directed radially inwards may comprise a bend or discontinuity, so that in operation the rolling element 4 actually only runs on raceways 5 and 6 and forms no further contact points on the face 6. This point may, for example, be a point which is located at a radially outermost position. The raceway may, for example, be an area of the ring which the rolling element is in contact with or where it rolls on the ring. Two raceways may, for example, be spaced apart in axial direction. The raceway may for example extend completely along the ring in the circumferential direction.

In some further non-illustrated embodiments, the face of the outer ring directed radially inwards may also be flattened at the area located at a radially outermost position. For example, the face may comprise the form of a gothic arch. Instead of the circular arc section the face comprising the raceways may also comprise straight sections in its cross-sectional form. The face may, for example, also comprise cross section in the form of a curve comprising a positive gradient in a first area. In this area, the first raceway may be arranged. In a second area, the curve may comprise a negative gradient. In this area, the second raceway may be arranged. Between the two areas, the curve may, for example, further comprise at least one discontinuity and/or at least one band, so that a third raceway or a third possible contact point at which the rolling element contacts the outer ring simultaneously to the first and the second raceway is omitted. The curve or the sections in the individual areas may in some further non-illustrated embodiments further comprise any possible forms, for example a straight line, a parabola or the like. Possibly, the raceways which may also be referred to as running surfaces may also be implemented as protrusions which have a greater extension radially inwards than areas which are adjacent in axial direction. In some embodiments, also different ones of the described forms may be combined at the face directed radially inwards and/or possibly even more than two.

In some further non-illustrated embodiments, the rolling-element bearing may also comprise a different number of raceways. The raceways may then all have the same form or may comprise different forms. The outer ring may, for example, comprise three or four raceways and the inner ring may comprise three, two or one raceway. Possibly, the rings may then no more correspond to a conventional inner ring of an angular contact ball bearing and a conventional outer ring of a four-point contact ball bearing but may be different from those rings.

The inner ring may comprise a section at a face 13 which is directed radially outwards which includes the raceway 8 and which is configured analog to the sections already described for the outer ring. The raceway 8 is arranged eccentrically. The raceway 8 is located at a side at which an axial load, represented by an arrow designated by reference numeral 30, acts upon the rolling-element bearing 1 or the inner ring 3. The force may depend on an application, a load case and/or a size of the bearing. For example, the force 30 may be a measuring load. The inner ring, at an edge area 14 which is located at the side of the raceway 8 in axial direction M and outside the same, may comprise a larger extension in the radially outward direction than on a side 15 which is opposite in axial direction. This may, for example, be the case as the inner ring 8 only comprises exactly one asymmetrically arranged raceway 8. Due to the fact that the inner ring 3 comprises a smaller extension in the radially outward direction at the side 15 and/or a front side 16, it may be enabled in some embodiments for lubricant to be introduced more easily. The front side 16 here is a front side facing away from the raceway 8. Apart from that, from the asymmetry possibly a pump effect may result and consequently a better distribution of the lubricant.

For the rolling element 4 the same contact angle a results at the raceway 5 of the outer ring and at the raceway 8 of the inner ring 3. The contact angle a is, for example, located between a straight line 10 connecting the opposing contact points of the rolling element on the raceways 5 and 8 which may also be referred to as nominal contact points and a perpendicular 11 through a center point m of the rolling element 4 onto the rotational axis M. A corresponding contact angle β at the raceway 7 which has no other opposing raceway may, for example, be defined as an angle between a straight line 12 connecting the center point m and the nominal contact point on the raceway 7 and the perpendicular 11. As the outer ring 2 is configured symmetrically, the contact angles α and β are equal. Each of the contact angles may, for example, be in a range of values comprising between 15°, 20°, 22°, 25°, 28°, 30°, 32°, 35°, 40°, 45° and/or 55°. In some further, non-illustrated embodiments the raceways at the outer ring 2 may also be arranged asymmetrically and/or the angles α and β may comprise different values.

Regarding a relative movement between the inner ring 3 and the outer ring 2, the inner ring 3 may be a movable component and the outer ring 2 may be a stationary component. Likewise, the outer ring 2 may be the movable component and the inner ring 3 the stationary component.

With a correct assembly and in case of an operation in a desired speed range, the rolling element 4 is simultaneously applied to and/or runs on the raceways 5 and 7 of the outer ring 2. The speed may, for example, be between 1,000,000 mm/min and 2,000,000 mm/min. For example, centrifugal forces may be responsible for this. This outer ring 2 is consequently stressed or used differently as compared a four-point contact ball bearing in which, for example, in a normal operation always only one raceway per ring is in contact with the rolling element. Radially inside, the rolling element 4 only runs on one raceway. A change of orientation of the rolling element 4 so that it is alternatingly applied to raceway 5 and then to the other raceway 7 may in some embodiments be prevented.

In other words, in some embodiments the rolling-element bearing may be described as a combination of an outer ring of a four-point contact ball bearing and an inner ring of an angular contact ball bearing, as a high-speed angular contact ball three-point or as a three-point contact ball bearing. By means of the special rolling-element bearing design, for example an inner geometry—contact angle, number and size of the rolling elements, rolling element material and/or cage design—in some embodiments a best possible suitability with respect to load and speed may be acquired. In some embodiments, a contact angle difference between the inner ring and the outer ring due to centrifugal forces may at least be reduced in non-stressed states of operation. Possibly, also an axial offset between the outer ring and the inner ring may be minimized. In some embodiments, the required functionality may be provided by an individual bearing. The possibly improved lubrication results may possibly lead to an improved cooling of the bearing and possibly also to a lower oil or lubricant consumption. By the use of the rolling-element bearing, in some systems an efficiency may be increased as fewer bearings and less oil or lubricant is required and the axial position is maintained more accurately. A reduced spread of the axial offset may possibly simplify a definition of the tolerance range of the bearing, for example with respect to reduced requirements regarding assembly or adjustment and possibly also a reduced accumulation of axial tolerances in an assembly. Possibly, in some embodiments, this way an accurate, constant and repeatable component or rotor positioning may be enabled. The simplified assembly may in some embodiments bring substantial advantages, in particular in serious production.

In some embodiments, a reduced axial movement of the inner ring as compared to the outer ring may result at high speed and/or varying states of load like full load or in an unloaded state of operation. In some embodiments, the outer ring may serve as an oil reservoir in order to prevent a dry start and a consequently resulting damage of the bearing. In some embodiments, the outer ring may offer a good guidance for a shoulder-guided cage also at high speed and vibration.

The rolling-element bearing according to embodiments may be utilized in any possible applications, for example high speed applications, but is not restricted thereto. Apart from that, the bearing may be used as an individual bearing, i.e. not in an O- or X-arrangement or not even in combination with another bearing. Such applications may, for example, be the case in vehicle construction, in the drive section, with a turbocharger or the like. A component which may be supported with the rolling-element bearing may, for example, be a rotor of a compressor, for example a screw compressor, any possible other rotors, a shaft in a housing or the like.

Embodiments disclosed in the above description, the subsequent claims and the attached drawings as well as their individual features may be of importance and implemented both individually and also in any combination for the implementation of an embodiment in its different forms.

In some further embodiments, features disclosed in other embodiments as an apparatus feature may also be implemented as method features. Further, if applicable, also features which are implemented as method features in some embodiments may be implemented as apparatus features in other embodiments.

### REFERENCE NUMERALS LIST

1 rolling-element bearing

2 outer ring

3 inner ring

4 rolling element

5 raceway

6 face directed radially inwards/outer ring

7 second raceway

8 raceway

9 cage

10 straight line

11 perpendicular

12 straight line

13 face directed radially outwards/inner ring

14 edge area

15 face

16 front face

30 force

M rotational axis

m center point/rolling element

α contact angle

β contact angle

1. A rolling-element bearing, comprising:
at least one outer ring;
at least one inner ring;
a plurality of rolling elements which are arranged to rotatably support the inner ring with respect to the outer ring;
wherein the outer ring comprises at least one raceway more for the plurality of rolling elements than the inner ring.

2. The rolling-element bearing according to claim 1, wherein the outer ring comprises two raceways and the inner ring comprises one raceway.

3. The rolling-element bearing according to claim 1, wherein a face of the outer ring which is directed radially inwards comprises, in its cross section, at least a section of a straight line and/or at least a section of a circular arc and/or at least a section of a protrusion profile each forming a raceway for the rolling element.

4. The rolling-element bearing according to claim 1, wherein in operation the rolling element is in contact with at least one raceway more than at an inner ring.

5. The rolling-element bearing according to claim 1, wherein the rolling element is a ball or a barrel roll.

6. The rolling-element bearing according to claim 1, wherein the rolling element comprises the same contact angle at at least two raceways of the outer ring.

7. The rolling-element bearing according to claim 1, wherein the rolling element comprises different contact angles at at least two raceways of the outer ring.

8. The rolling-element bearing according to claim 1, wherein the inner ring comprises a smaller extension in the radially outward direction at an area of a face (13) directed radially outwards than at a side which is opposite in axial direction.

9. A high-speed support for rotatably supporting a first component with respect to a second component comprising at least one rolling-element bearing, comprising:
at least one outer ring;
at least one inner ring;
a plurality of rolling elements which are arranged to rotatably support the inner ring with respect to the outer ring;
wherein the outer ring comprises at least one raceway more for the plurality of rolling elements than the inner ringaccording-to any of the previous-el-aims,
wherein the first component comprises a speed factor of at least 750,000 mm/min with respect to the second component.

10. A compressor comprising at least one rolling-element bearing, comprising:
at least one outer ring;
at least one inner ring;
a plurality of rolling elements which are arranged to rotatably support the inner ring with respect to the outer ring;
wherein the outer ring comprises at least one racewa more for the plurality of rolling elements than the inner ring,
which is implemented to rotatably support a rotor and/or a high speed support for rotatably suppoting a first com onent with resect to a second com onent comprising at least one rolling-element bearing, comprising:
at least one outer ring;
at least one inner ring;
a plurality of rolling elements which are arranged to rotatably support the inner ring with respect to the outer ring;
wherein the outer ring comprises at least one raceway more for the plurality of rolling elements than the inner ring,
wherein the first component comprises a speed factor of at least 750,000 mm/min with respect to the second component,
wherein a rotor of the compressor is the first component.
